(19) United States
(12) Patent Application Publication
(10) Pub. No.: US 2003/0187937 A1
(43) Pub. Date: Oct. 2, 2003

(54) Using fuzzy-neural systems to improve e-mail handling efficiency

(76) Inventors: Timothy Hun-Jen Yao, Naperville, IL (US); Michael Ming-Ku Wu, Naperville, IL (US)

Correspondence Address: Richard J. Minnich, Esq., Fay, Sharpe, Fagan, Minnich & McKee, LLP, Seventh Floor, 1100 Superior Avenue, Cleveland, OH, 44114-2518, US

(21) Appl. No.: 10/109,269

(22) Filed: Mar. 28, 2002

(51) Int. Cl. G06F 15/16; G09G 5/00

(52) U.S. Cl. 709/206; 706/934; 345/744

(57) ABSTRACT

A method for handling e-mail messages includes defining a set of rules, and applying the set of rules to received e-mail messages. Importance ratings are assigned to the received e-mail messages based upon the application of the set of rules, and actions taken by a user with respect to the received e-mail messages are monitored. The method further includes modifying the set of rules based upon the monitored actions taken with respect to the received e-mail messages.

### FIELD OF THE INVENTION

The present invention relates to electronic mail, commonly known as e-mail, and e-mail clients that handle the same. It will be described with particular reference thereto, however, it is to be appreciated that the present invention is also amenable to other like applications, e.g., wireless text messaging and the like.

### BACKGROUND OF THE INVENTION

The widespread use of and/or access to the Internet and other computer networks, e.g., intranets, and other public and private communication networks, has led to the proliferation of text base messaging, and in particular, e-mail communication. In fact, the popularity of e-mail communication in various settings often results in an e-mail recipient being overwhelmed with e-mail messages. The problem is further exacerbated by the mass mailing practices of solicitors and others that routinely send out what is commonly known as “spam” or “junk” e-mail, i.e., unwanted and/or unrequested e-mail. Even within a corporate or academic environment, it is not unusual for key people to receive more than 100 legitimate e-mail messages per day. Receiving large volumes of e-mail makes it difficult to organize the individual messages in a manner meaningful to the recipient. Accordingly, it is desirable to have an e-mail client and/or method of handling e-mail that automatically sorts or otherwise organizes e-mail messages in a manner meaningful to the recipient.

Typical e-mail clients sort messages by some default hierarchy, e.g., chronologically, alphabetically by the subject line title or the sender's name, etc. Commonly, they also have some additional sorting or organizing features. These features however are often limited or otherwise less then ideal. For example, an e-mail client may allow the recipient to manually go though an “inbox” where incoming e-mail messages are received, and move desired messages to various labeled folders or otherwise dispose of them as they see fit. This process, however, is a manual and time consuming effort which involves the direct participation of the recipient.

An e-mail client may also allow the recipient to define rules or set filters that automatically process incoming e-mail based upon the particular characteristics or attributes of the message itself, e.g., the content of the message, the sender of the message, the time and/or date it was sent or received, etc. Commonly, these types of rules or filters operate by using predefined search expressions to identify which messages meet defined criteria. Identified messages are then disposed of in a set manner specified in the rule or filter. Again, defining the rules and/or setting the filters involves the direct participation of the recipient. Additionally, if a change is desired, the rules or filters can only be adapted by the direct participation of the recipient.

Still other e-mail clients may permit the sender to assign values to or otherwise mark an e-mail message thereby alerting a recipient to its urgency and/or importance. The recipient is then able to use the assigned value or marking as the sorting or filtering criteria. However, the assigned value or marking indicates the urgency or importance of the e-mail message from the sender's point of view, not the recipient's point of view that very well may be different.

The present invention contemplates a new and improved method, software and/or apparatus for handling e-mail which overcomes the above-referenced problems and others.

### SUMMARY OF THE INVENTION

In accordance with an aspect of the present invention, a method for handling e-mail messages is provided. The method includes defining a set of rules, and applying the set of rules to received e-mail messages. Importance ratings are assigned to the received e-mail messages based upon the application of the set of rules, and actions taken by a user with respect to the received e-mail messages are monitored. The method further includes modifying the set of rules based upon the monitored actions taken with respect to the received e-mail messages.

In accordance with another aspect of the present invention, an e-mail client is provided which receives and handles e-mail messages. The e-mail client includes a set of rules, and application means for applying the set of rules to received e-mail messages. Rating means assign importance ratings to the received e-mail messages base upon the application of the set of rules, and monitoring means monitor actions taken by a user with respect to the received e-mail messages. Regulating means modify the set of rules based upon the monitored actions taken with respect to the received e-mail messages.

One advantage of the present invention is that it allows for e-mail organization which is meaningful to the recipient.

Another advantage of the present invention is that it optionally employs fuzzy rules which are better suited than crisp rules for hard to quantify concepts, e.g., distinguishing between a nicely brief message length and overly long message length.

Yet another advantage of the present invention is that preferably the set of rules applied to determine the importance of e-mail is regulated and/or updated without direct intervention on the part of the user.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment(s) and are not to be construed as limiting the invention. Further, it is be appreciated that the drawings are not to scale.

FIG. 1 is a flow chart showing the operation of an e-mail client in accordance with aspects of the present invention.

FIG. 2 is a diagrammatic illustration of an exemplary graphical user interface for an e-mail client in accordance with aspects of the present invention.

FIG. 3 is a diagrammatic illustration showing an e-mail client system in accordance with aspects of the present invention.

### DETAILED DESCRIPTION OF THE INVENTION

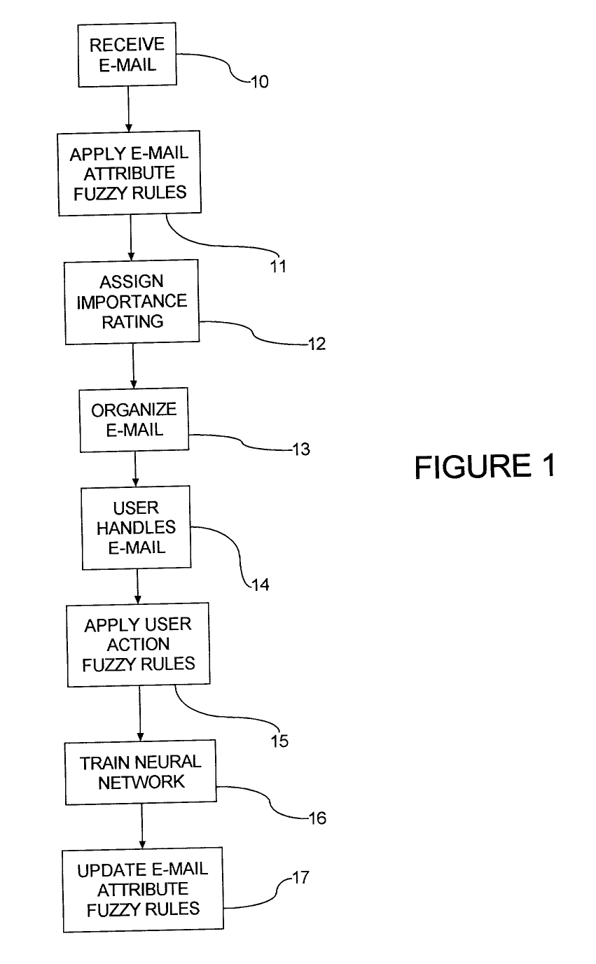

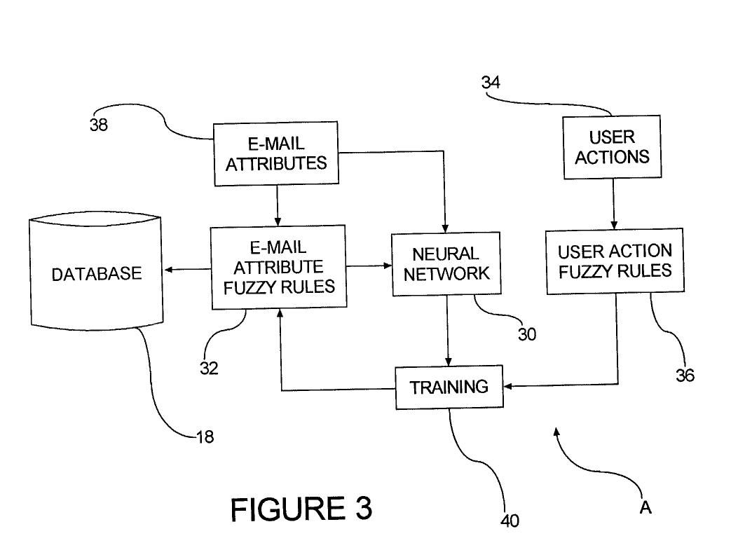

With reference to FIGS. 1 and 3, an e-mail client A is installed and runs on a computer (not shown). The e-mail client A receives e-mail messages 10 in the usual manner. Preferably, in addition to the novel functionality and features described herein, the e-mail client 10 offers the user or e-mail recipient any or all of the options commonly available in known e-mail clients. While for simplicity herein reference is made mainly to e-mail and e-mail messages, it is to be appreciated that the present invention is equally applicable to other text messaging applications. Accordingly, e-mail, an e-mail message and/or e-mail messages, as referred to herein, also include other types of text messaging applications and/or text messages. Similarly, reference to an e-mail client shall also be deemed to reference other platforms for handling text messaging as are known in the art. The e-mail client A or any one or more of its components are optionally implemented via hardware, software, or a combination thereof.

After receipt, the e-mail has a set of e-mail attribute rules 32, preferably fuzzy, applied thereto 11. Preferably, the rules are applied to each e-mail message as it is received, or alternately they may be applied at some later time, e.g., with batch processing of the e-mail. The fuzzy rules operate based on what is known in the art as fuzzy logic or fuzzy set theory. Crisp or classical logic is based on set theory where a member either belongs to a set or it does not. For example {1,2,3,−1,−2,−3} belong to the set called Integers. {1.2,1.3,1.5} belong to the set of real numbers, but not to the set of integers. For instance, the color of a ball could be in the set {red, blue, green}. However, when the ball is somewhat red, that concept cannot be quantified by discrete mathematical set theory. Fuzzy logic or fuzzy set theory solves this problem by allowing the members of a set to have certain grades of membership that will quantify fuzzy criteria such as not very red, somewhat red, fairly red, very red, etc. Fuzzy logic is a multi-valued (as opposed to binary) logic developed to deal with imprecise or vague data. That is to say, classical or crisp logic holds that everything can be expressed in binary terms: 0 or 1, black or white, yes or no; in terms of Boolean algebra, everything is in one set or another but not in both. Fuzzy logic on the other hand uses membership functions to allow for partial membership in a set, i.e., values between 0 and 1, shades of gray. Fuzzy set theory appears to have been first proposed by L. A. Zadeh in the 1960s. See, e.g., Zadeh, Lotfi, “Fuzzy Sets,” Information and Control 8:338-353, 1965.

Preferably, the e-mail attribute rules 32 are maintained in and accessed from a database 18. That is to say, the database 18 stores the membership functions that define the rules including the coefficients and/or other parameters that define the membership functions. The set of e-mail attribute rules 32 relate the particular characteristics or attributes of an e-mail to its overall “importance.” Optionally, the rules are a combination of both fuzzy and crisp rules.

Preferably, the characteristics or attributes which are used to determine an e-mail message's importance include: the name of the sender, the length or size of the message or parts thereof, addressing information, subject line information, the time and/or date, if the message is a reply or forwarded message, the message content or keywords, the presence and/or size of attachments, an importance or urgency indication assigned by the sender, etc. For example, from the addressing information, it can be determined: whether the recipient was in the “to” line, the “cc” line or the “bcc” line; how many other people the e-mail message was sent to and which lines the others appeared in; who else it was sent to and where they appeared in the addressing lines, etc. These characteristics can then be related to the importance of the e-mail message. That is to say, for example: when the recipient is the only one to whom the e-mail message was sent, a higher importance can be inferred as compared to when the e-mail message is sent to many people, i.e., the importance may be inversely proportional to the number of people to whom the e-mail message is sent; also, when the recipient is in the “to” line, a higher importance can be inferred as compared to being in the “cc” line. Similarly, importance may depend on the message length, i.e., it could be decided that nicely brief e-mail messages are of higher importance compared to overly longer e-mail messages. In such cases, both the message length and the importance are fuzzy concepts that are best represented by fuzzy variables. Still other rules could relate a sender's name or e-mail address to a level of importance of an e-mail message, or the term “Re:” in the subject line could indicate higher importance as compared to no “Re:” in the subject line insomuch as the “Re:” may indicate the e-mail message is a response to one the recipient previously sent, or other keywords could be related to levels of importance.

Having applied the fuzzy rules, each e-mail message is assigned an “importance rating” 12. The importance rating assigned to an e-mail message is based upon the outcome of applying the e-mail attribute fuzzy rules 32 to that message. More particularly, the application of each rule in the set of fuzzy rules to an e-mail message results in a “score” which depends on the form of the membership function associated with that rule. Preferably, all the scores are optionally weighted and combined to produce the importance rating (IR) for the e-mail message under consideration. The optional weighting reflects the relative effects each rule is to have on the resulting importance rating. Alternately, the weighting can be built into the fuzzy rules through the use of fuzzy or crisp modifiers of those rules. Preferably, the specific form of each membership function will vary as more fully described below to model the actual importance a particular user attributes or imputes to their e-mail.

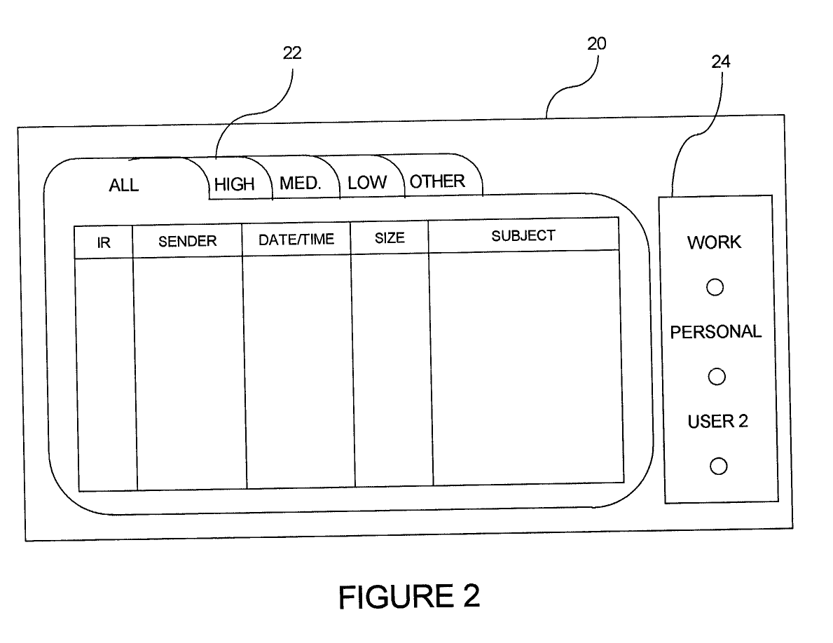

The e-mail messages are preferably organized 13 based at least partially on their respective importance rating. With reference to FIG. 2, a graphical user interface (GUI) 20 depicts a number of tabbed folders 22. In this exemplary embodiment, the tabbed folders 22 are labeled with the headings: ALL; HIGH; MED.; LOW, and OTHER. Optionally, the folders 22 each contain a copy of their respective e-mail messages. Alternately, the e-mail messages are all stored in a common database or location and the folders 22 represent filtered and/or sorted views from which the e-mail messages are accessible. In the later case, system memory and/or other e-mail storage resources can be conserved insomuch as duplicate copies of the same e-mail message are not placed in multiple folders 22.

Preferably, from the ALL folder 22, a user may selectively access all the received e-mail messages. Similarly, those messages with high importance ratings are selectively accessible from the HIGH folder 22, those messages with medium importance ratings are selectively accessible from the MED. folder 22, and those messages with low importance ratings are selectively accessible from the LOW folder 22. That is to say, the HIGH, MED. and LOW folders 22 are each associated with a filter so that only e-mail messages with IRs within selected ranges appear in each respective folder.

For example, assuming an importance rating scale of 0 (i.e., no importance) to 100 (i.e., maximum importance), then the HIGH folder 22 could optionally be associated with a filter that only allowed e-mail messages that satisfied 60<IR≦100 to appear therein; the MED. folder 22 could optionally be associated with a filter that only allowed e-mail messages that satisfied 40<IR≦60 to appear therein; and, the LOW folder 22 could optionally be associated with a filter that only allowed e-mail messages that satisfied 20<IR≦40 to appear therein. Of course, these ranges are merely exemplary and can be tailored to an individual user's preferences. Additionally, the ranges can be made to overlap so that e-mail messages with IRs that are marginal (i.e., fall within the overlap) with respect to any two folders would appear in both folders. Further, more or less folders 22 for more or less finely graduated organization may be employed. This essentially fuzzifies the importance rating since the fuzzy rules cannot be expected to compute crisp IR values with complete accuracy.

Within any one folder 22, the e-mail is optionally sorted in ascending or descending order based upon one or more chosen criteria. That is to say, within any one folder 22, the e-mail messages appearing therein may be sorted by the relative IR of the e-mail messages, chronologically, alphabetically by the subject line title or sender's name, etc. Preferably, along with other e-mail attributes (i.e., subject line title, sender's name, time and date, size, etc.), the e-mail listings in each folder 22 also show the IR of each e-mail message. The IR values themselves may be displayed or some other indication or symbolic representation of their values may be communicated to the user, e.g., use of color hues or intensity.

The OTHER folder is optionally associated with another filter designated or defined by the user and can be alternately named as desired. Furthermore, multiple such folders may be created as the user sees fit. Such folders may be associated with filters so that they display or otherwise contain all the e-mail messages received from a particular sender, or all the messages containing a particular keyword in the subject line, or the like.

With reference again to FIGS. 1 and 3, a neural network 30 is preferably employed to develop and adjust the e-mail attribute fuzzy rules 32 (or optionally a combination or fuzzy and crisp rules) that are loaded and maintained in the database 18. The neural network 30 is optionally implemented in any form commonly known in the art. The neural network 30 regulates the specific form of each membership function associated with the e-mail attribute fuzzy rules 32 applied to received e-mail messages so as to model the actual importance a particular user attributes or imputes to their e-mail. Preferably, the neural network 30 learns or is trained by the actions a user takes with respect to each e-mail message received. That is to say, as the user handles e-mail messages 14, the e-mail client A monitors the user actions 34 taken with respect to each e-mail message received. These user actions are then used to determine the importance attributed to the e-mail by the user.

The monitored user actions 34 preferably include the disposition of the e-mail message under consideration (i.e., it was bounced, the user deleted it immediately, the user opened it, the user saved it, the user replied to it, the user forwarded it, the user kept it in the inbox or queue, the user moved it to a folder, the user printed it, etc.); the length of time the user took to read the message, i.e., the length of time the e-mail message remained open; and, the form and/or nature of any resulting e-mail sent by the user in response to a received e-mail message (i.e., how many individuals were sent resulting e-mails, who were sent resulting e-mails; were they forwarded or replies; etc.). Note again that many of these concepts are best represented with fuzzy variables.

Based on the monitored user actions 34, the importance of the e-mail message under consideration to the user is determined. A set of user action rules 36, optional fuzzy or crisp or a combination of both, is applied 15 so as to determine an actual or target IR for a given e-mail message based upon the monitored user actions 34 associated with that e-mail message. For example, if a user immediately deletes the e-mail message without reading it, this would indicate a lower IR as compared to an e-mail message the user takes time to read. Similarly, an e-mail message that gets replied to or forwarded would indicate a higher IR as compared to one that does not. In this manner, the actual importance ascribed or imputed to the e-mail message by the user is determined from their treatment of and/or reaction to the message. At step 16, this actual importance is then used to train the neural network 30 so that it may update 17 the e-mail attribute fuzzy rules.

The set of user action rules 36 map or relate the monitored user actions 34 to IR. These user action rules preferably are based upon or model the normal reactions of a given population. The set of user action rules 36 are optionally adjustable to suit different populations or classes or types of users, e.g., business executives, academics, students, home users, technical types, professionals, etc., may all represent different populations. They are preferably determined from empirically studying or otherwise obtaining empirical data on the reactions of individuals within the population to e-mail (i.e., user actions taken with respect to received e-mail) and the importance they impute or attribute to that e-mail.

The neural network 30 also takes a given e-mail message and applies the set of e-mail attribute rules 32 thereto so as to determine a computed IR based upon the e-mail attributes 38 of the message. This computed IR is then compared to the actual or target IR. The training 40 of the neural network 30 is based upon this comparison. That is to say, the output of the neural network 30 acts as feedback which is used to adjust or modify the set of e-mail attribute fuzzy rules 32 so that the computed IR more closely matches the actual or target IR to which it is being compared. Preferably, the output includes the parameters and/or coefficients which define the membership functions or other equations associated with the rules 32. Alternately, the output may include amounts by which to change the aforementioned parameters and/or coefficients. Preferably, the changes to the parameters and/or coefficients are incremental, utilizing a neural network training scheme to impart a sense of inertia to the e-mail attribute fuzzy rules 32.

For example, if the computed IR is higher than the actual or target IR, the neural network 30 generates an output which is feedback into the set of e-mail attribute rules 32 thereby changing or modifying the same so as to produce a computed IR which is closer to the actual or target IR. The modification in this case would result in one or more selected e-mail attributes being given less weight or affecting a lowered importance in the IR computation. For example, the rules governing the IR calculation may be modified so that messages from a particular sender or having a particular message length result in a relatively lower IR computation has compared to the time previous.

In any event, over a number of iterations or evolutions, the neural network 30 adjusts the set of e-mail attribute rules 32 so that when they are applied the computed IRs resulting therefrom substantially match the actual or target IRs which are based upon the monitored user actions 34. That is to say, the neural network 30 learns from the user's own reactions to e-mail the importance that the user attributes to the e-mail. Based on this knowledge or training 40, the set of e-mail attribute rules 32 for determining and/or assigning importance to e-mail messages is developed and maintained. Ultimately, the e-mail is organized at least partially based upon the determined and/or assigned importance. In this manner, the organization of the e-mail is achieved in a fashion which is meaningful to the recipient or user. Moreover, the meaningful organization is achieved without direct intervention on the part of the user. That is to say, the recipient or user does no more than what they would otherwise do with their e-mail, i.e., read it, delete it, reply to it, forward it, save it, etc.

In an alternate embodiment, the user may directly train the neural network 30. For example, the IR for a given e-mail message can be manually assigned by the user. This action would then teach the neural network 30 that other e-mail with one or more similar attributes should be receiving higher or lower IRs as the case may be depending upon the manual assignment. Via the feedback, the neural network 30 would then adjust or modify the set of e-mail attribute rules 32 accordingly. Optionally, the actual or target IR can be based upon the folder 22 (see FIG. 2) in which the user desires an e-mail message to appear. For example, if an e-mail message appears in the LOW folder 22 but the user would in fact deem or desire it to be more appropriately found in the HIGH folder 22, the user may simply move it, perhaps by clicking and dragging it into the HIGH folder 22 or otherwise. This action would then teach the neural network 30 that other e-mail with one or more similar attributes should be receiving higher IRs. The neural network 30 would again adjust or modify the set of e-mail attribute rules 32 accordingly.

In a preferred embodiment, there are a plurality of sets of e-mail attribute rules 32 and optionally a plurality of sets of user action rules 36. By using a plurality of sets of e-mail attribute rules 32, different users may employ the e-mail client A and have the rules in each case tailored to each specific user by the neural network 30. Similarly, different sets of user action rules 36 train the neural network 30 in accordance with models that represent different populations or types of people. This way, the training of the neural network 30 can be chosen based upon the type of user. Optionally, the different sets of e-mail attribute rules 32 do not correspond to actual different users. Rather, it may be the same user wearing different “hats” or assuming different roles, e.g., a work role in one instance and personal role in another instance. In this manner, different sets of e-mail attribute rules 32 can be developed and/or maintained thereby providing different meaningful organizations of e-mail base upon the user's selected role. Referring again to FIG. 2, the GUI 20 optionally includes radio buttons 24 or the like that are labeled and chosen by the user as desired to control the selection of and/or otherwise activate the associated set of e-mail attribute rules 32 and/or set of user action rules 36.

The invention has been described with reference to the preferred embodiment(s). Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method for handling e-mail messages comprising:
defining a set of rules;
applying the set of rules to received e-mail messages;
assigning importance ratings to the received e-mail messages base upon the application of the set of rules;
monitoring actions taken by a user with respect to the received e-mail messages; and,
modifying the set of rules based upon the monitored actions taken with respect to the received e-mail messages.

2. The method of claim 1, wherein the set of rules include at least one fuzzy rule.

3. The method of claim 1, wherein the monitored actions include at least one of replying to a received e-mail message, forwarding a received e-mail message, bouncing a received e-mail message, reading a received e-mail message, printing a received e-mail message, deleting a received e-mail message, and saving a received e-mail message.

4. The method of claim 1, wherein the applied set of rules relate attributes of each e-mail messages to that e-mail message's importance, said attributes including at least one of sender identity, subject line title, number of recipients, which address line the user appears in or if the user was part of an alias or blind carbon copy, presence of an attachment, number of and type of attachment if present, message length, message date relative to the current date, message history threading and e-mail message size.

5. The method of claim 1, further comprising:
organizing the received e-mail messages at least partially based on their importance ratings.

6. The method of claim 5, further comprising:
displaying the received e-mail messages along with an indication of their respective importance ratings.

7. The method of claim 1, further comprising:
filtering the e-mail messages based upon their assigned importance ratings; and,
displaying lists of e-mail messages, each of said lists including therein e-mail massages having importance ratings within a range associated with that list.

8. The method of claim 7, wherein at least two lists have ranges that overlap such that an e-mail message having an importance rating within the overlap is included in both lists.

9. The method of claim 1, further comprising:
defining a plurality of sets of rules; and,
activating one of the plurality of sets of rules in response to a selection received from the user.

10. The method of claim 2, wherein the at least one fuzzy rule is defined by a membership function, said membership function being defined by one or more function coefficients and parameters.

11. The method of claim 10, wherein the set of rules is modified by changing at least one of the one or more function coefficients and parameters.

12. An e-mail client which receives and handles e-mail messages, said e-mail client comprising:
a set of rules;
application means for applying the set of rules to received e-mail messages;
rating means for assigning importance ratings to the received e-mail messages base upon the application of the set of rules;
monitoring means for monitoring actions taken by a user with respect to the received e-mail messages; and,
regulating means for modifying the set of rules based upon the monitored actions taken with respect to the received e-mail messages.

13. The e-mail client of claim 12, wherein the set of rules comprises at least one fuzzy rule.

14. The e-mail client of claim 12, wherein the set or rules are maintained in a database.

15. The e-mail client of claim 12, wherein the regulating means comprises a neural network.

16. The e-mail client of claim 15, further comprising:
a set of training rules, said set of training rules relating the monitored user actions taken with respect to a received e-mail message to that e-mail message's importance to the user, said neural network being trained by applying the set of training rules to input from the monitoring means.

17. The e-mail client of claim 15, wherein output from the neural network acts as feedback that is used to modify the set of rules.

18. The e-mail client of claim 12, further comprising:
a graphical user interface which displays received e-mail messages such that the received e-mail messages are organized at least partially based upon their importance ratings.

19. The e-mail client of claim 18, wherein the graphical user interface displays along with each e-mail message an indication of that e-mail message's importance rating.

20. The e-mail client of claim 18, wherein the graphical user interface displays lists of e-mail messages, each of said lists including therein e-mail messages having importance ratings within a range associated with that list.
